(19) United States
(12) Patent Application Publication
(10) Pub. No.: US 2005/0251786 A1
(43) Pub. Date: Nov. 10, 2005

(54) System and method for dynamic software installation instructions

(75) Inventors: Andrew P. Citron, Raleigh, NC (US); Arthur R. Francis, Raleigh, NC (US); Dorian B. Miller, Chapel Hill, NC (US); Martin Presler-Marshall, Chapel Hill, NC (US)

Correspondence Address: VAN LEEUWEN & VAN LEEUWEN, P.O. BOX 90609, AUSTIN, TX, 78709-0609, US

(73) Assignee: International Business Machines Corporation, Armonk, NY (US)

(21) Appl. No.: 10/841,747

(22) Filed: May 7, 2004

(51) Int. Cl. G06F 9/44

(52) U.S. Cl. 717/106; 717/136

(57) ABSTRACT

A system and method for dynamic software installation instructions is presented. A customized instruction generator asks a user particular questions. In turn, the user provides answers, or system parameters. Based upon the user's response, the customized instruction generator asks dependent questions to further collect more detailed system parameters. Once the customized instruction generator collects the system parameters it requires, the customized instruction generator retrieves an instruction template that includes parameter placeholders. The customized instruction generator replaces the parameter placeholders with corresponding system parameters, includes particular instruction subsections based upon the system parameters, and generates customized instructions for the user to follow in order to install software on a computer system.

### BACKGROUND OF THE INVENTION

1. Technical Field

The present invention relates in general to a system and method for generating dynamic software installation instructions. More particularly, the present invention relates to a system and method for using system parameters to generate customized instructions for use in the process of installing software on a particular computer system.

2. Description of the Related Art

Large computer systems are becoming increasingly complex. A large computer system may have multiple components, such as servers, databases, directories, etc. In addition, a large computer system typically executes a large software system that includes several software packages. A challenge found with maintaining large computer systems is the process of installing and updating these large software systems.

In a personal computer (PC) environment, software manufacturers are able to provide software that is relatively “user independent” and, therefore, not prone to errors during the installation process. For example, a user may purchase software on a compact disc, insert the compact disc into the PC, and the PC automatically loads the software after the user agrees to accept a licensing agreement and perhaps answers a few basic questions.

In a large computer system environment, however, installing software is not as straightforward as in a PC environment. A large software system may involve several software packages and machines, and the process is typically time-consuming and complicated. A user must track many system parameters while installing the software, such as machine names, software associated with the machines, etc. To complicate matters, a user is typically required to follow generic instructions that refer to a system in generalized terms, such as “DB machine.” The software installation process may easily be overwhelming, frustrating, and, in effect, error prone because the user has to continually remember to replace the generalized terms in the instructions with system parameters that are specific to his computer system.

In addition, generic instructions must often support several installation options that result in “blocks” of instructions. For example, generic instructions may include wording such as “If you are using a database on a separate system, perform steps 1-3, otherwise, perform only step 3.” A challenge found with these blocks of instructions is that is leads to further confusion for the user during an already complicated and cumbersome task.

What is needed, therefore, is a system and method for generating customized instructions for installing software that are specific to a particular computer system.

### SUMMARY

It has been discovered that the aforementioned challenges are resolved by using system parameters in combination with an instruction template for creating customized instructions in which a user follows during the process of installing a software system. A customized instruction generator asks a user particular questions regarding his computer system. In turn, the user provides answers, or system parameters. The customized instruction generator retrieves an instruction template that includes parameter placeholders, and replaces the parameter placeholders with corresponding system parameters in order to generate customized instructions.

A user wishes to load software on a computer system. The software may be a large software system that includes several software packages and the computer system may include many clients, servers, and peripheral devices. In order to facilitate the software installation process, the user uses a customized instruction generator to generate customized instructions that are specific to the software and the computer system. The customized instruction generator begins by providing system questions to the user in order to collect information regarding the computer system. The system questions correspond to particular system parameters in which the customized instruction generator requires. For example, the customized instruction generator may wish to know whether the user wishes to use a directory server.

The user reads the system questions, and provides corresponding answers (e.g. system parameters) to the customized instruction generator. Depending upon the user's answers, the customized instruction generator provides additional, dependent system questions. Using the example described above, if the user wishes to use a directory server, then the customized instruction generator may ask additional questions that are particular to the directory server, such as “What type of directory server?”

Once the customized instruction generator has collected the system parameters it requires from the user, the customized instruction generator retrieves an instruction template that includes one or more parameter placeholders, such as “Host Name.” The customized instruction generator retrieves the system parameters, replaces the parameter placeholders with the system parameters, and generates customized instructions. The customized instructions include instruction sub-sections that are particular to the computer system. For example, if a user is using a directory server, the customized instructions include sections corresponding to the directory server. On the other hand, if the user is not using a directory server, these sections are not included in the customized instructions. The customized instruction generator provides the customized instructions the user, which, in turn, the user uses in order to load the software on to the computer system.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 is a diagram showing a user providing system parameters to a customized instruction generator, which, in turn, uses the system parameters to generate customized instructions;

FIG. 2 is a user interface window showing a top-level question, dependent questions, and answers corresponding to the questions;

FIG. 3 is a high-level flowchart showing steps taken in a user providing system parameters and receiving customized instructions, which the user follows in order to load software on a computer system;

FIG. 4 is detail level flowchart showing steps taken in displaying questions and receiving system parameters that correspond to the questions;

FIG. 5 is a flowchart showing steps taken in generating customized instructions using system parameters;

FIG. 6 is an example of customized instructions that are generated using collected system parameters; and

FIG. 7 is a block diagram of an information handling system capable of implementing the present invention.

### DETAILED DESCRIPTION

The following is intended to provide a detailed description of an example of the invention and should not be taken to be limiting of the invention itself. Rather, any number of variations may fall within the scope of the invention which is defined in the claims following the description.

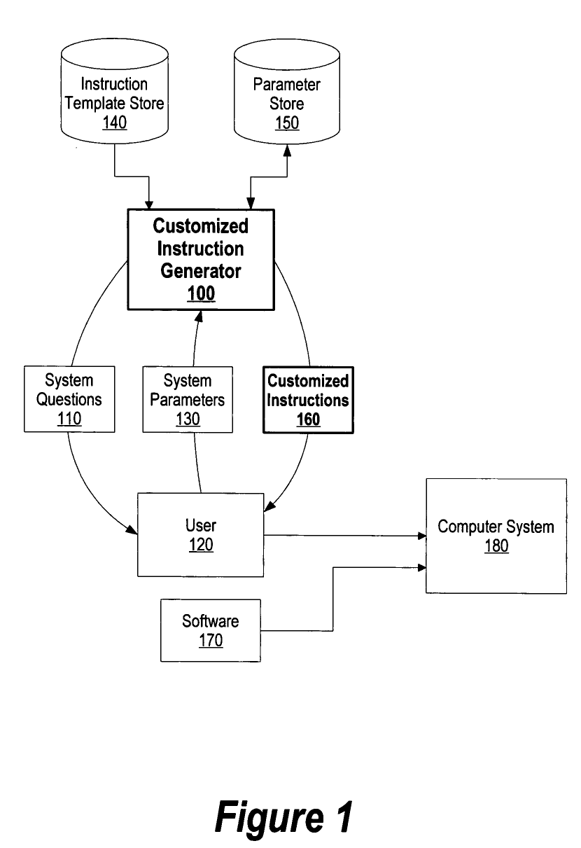

FIG. 1 is a diagram showing a user providing system parameters to a customized instruction generator, which, in turn, uses the system parameters to generate customized instructions. User 120 wishes to load software 170 on computer system 180. Software 170 may be a large software system that includes several software packages. In addition, computer system 180 may include many clients, servers, and peripheral devices.

In order to facilitate the software installation process, user 120 uses customized instruction generator 100 to generate customized instructions that are specific to software 170 and computer system 180. Customized instruction generator 100 begins by providing system questions 110 to user 120 in order to collect information regarding computer system 180. System questions 110 correspond to particular system parameters in which customized instruction generator 100 requires. For example, customized instruction generator 100 may wish to know whether user 120 wishes to use a directory server.

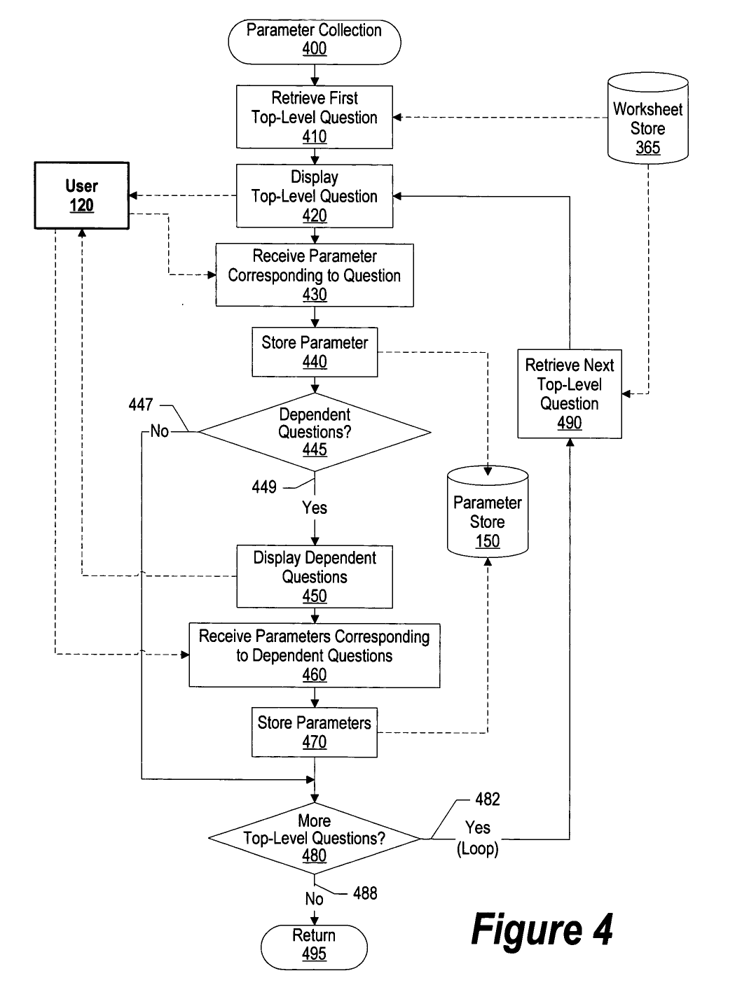

User 120 reads system questions 110, and provides answers (e.g. system parameters 130) to customized instruction generator 100. Customized instruction generator 100 receives system parameters 130 and stores them in parameter store 150. Parameter store 150 may be stored on a nonvolatile storage area, such as a computer hard drive. Depending upon user 120's answers, customized instruction generator provides additional dependent system questions. Using the example described above, if user 120 does wish to use a directory server, then customized instruction generator 100 may ask additional questions that are particular to the directory server, such as “What type of directory server?” (see FIG. 4 and corresponding text for further details regarding system parameter collection).

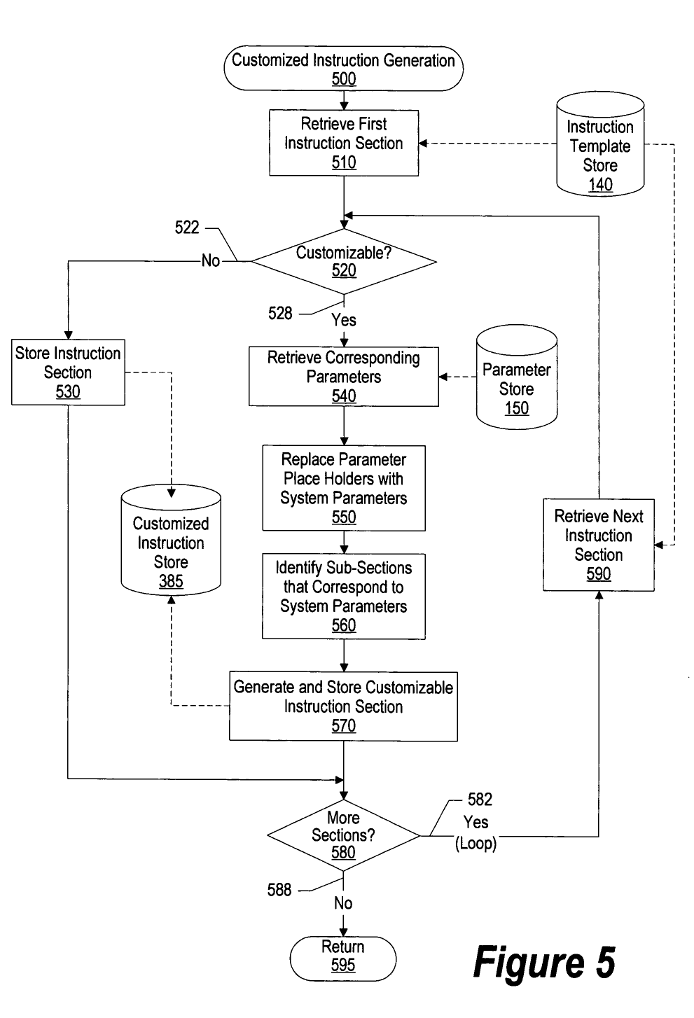

Once customized instruction generator 100 has collected the system parameters it requires from user 120, customized instruction generator 100 retrieves an instruction template from instruction template store 140. The instruction template includes one or more parameter placeholders, such as “Host Name.” Customized instruction generator 100 retrieves the system parameters that are stored in parameter store 150, replaces the parameter placeholders with the system parameters, and generates customized instructions 160 (see FIG. 5 and corresponding text for further details regarding customized instruction generation).

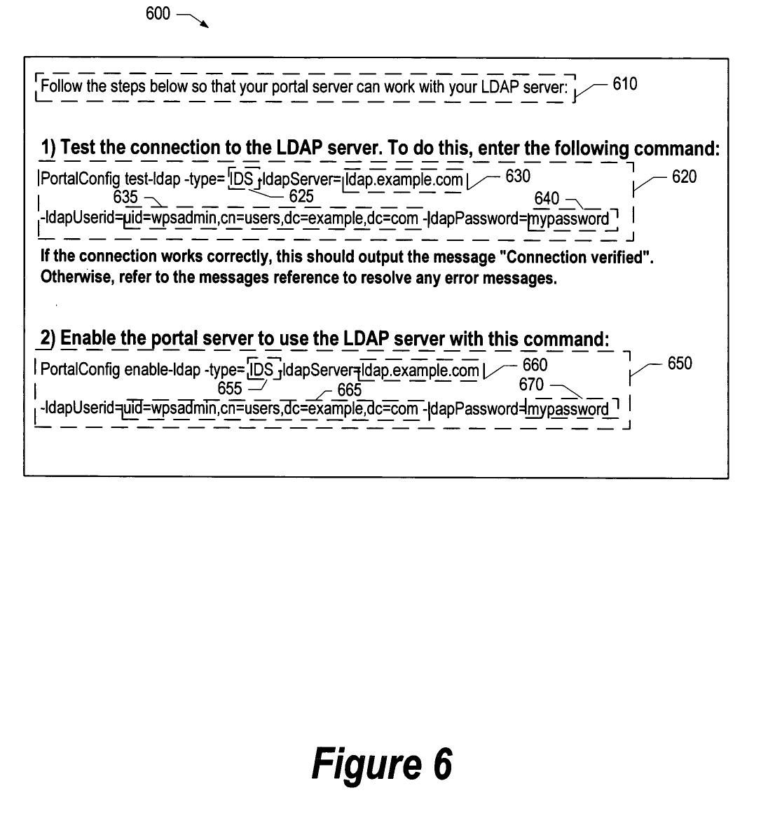

Customized instruction generator 100 provides customized instructions 160 to user 120. In turn, user 120 uses customized instructions 160 to load software 170 on computer system 180 (see FIG. 6 and corresponding text for further details regarding customized instructions).

In one embodiment customized instruction generator 100 allows for a user to change his configuration preferences. For example, a user may proceed through the customized instruction generation process, and change his mind as to whether he will be using a directory server. In this embodiment, customized instruction generator 100 identifies which system questions are effected by the user's decision, and asks the user to answer the effected system questions.

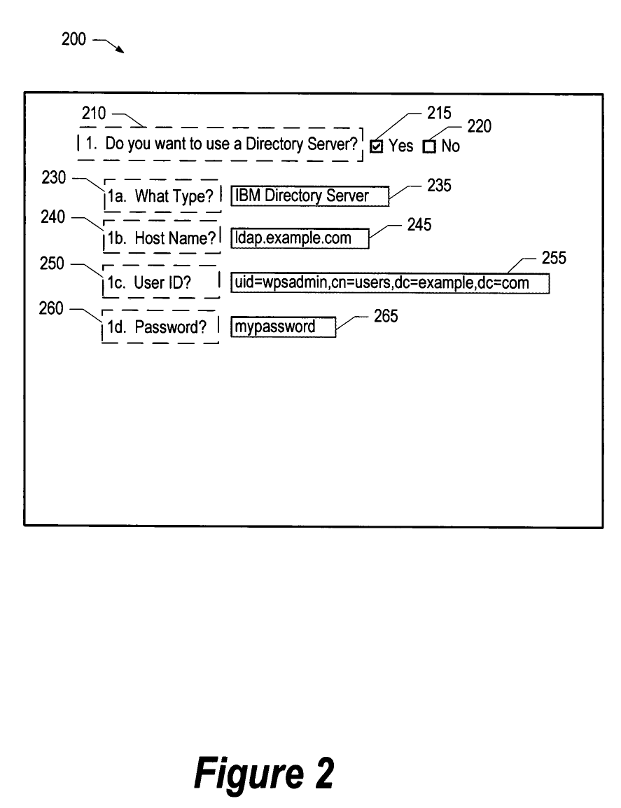

FIG. 2 is a user interface window showing a top-level question, dependent questions, and answers corresponding to the questions. A customized instruction generator provides particular questions to a user, which, in return, the user provides corresponding answers, or system parameters.

Window 200 includes question 210 and corresponding check boxes 215 and 220. Question 210 is a top-level question whereby a user selects either check box 215 or 220 to answer. If a user plans to use a directory server, the user selects check box 215. On the other hand, if a user does not plan to use a directory server, the user selects check box 220.

Depending upon a user's answer to question 210, the customized instruction generator displays questions 230 through 260. For example, if the user answers “No” to question 210, the customized instruction generator does not display questions 230 through 260. On the other hand, if the user answers “Yes” to question 210, the customized instruction generator displays questions 230 through 260 which ask more detailed questions corresponding to the directory server.

In order to answer question 235, the user enters, or selects from a pull down menu, a type of directory server in box 235. The example in FIG. 2 shows that the user is using an “IBM Directory Server.” In order to answer question 240, the user enters a host name in box 245 that corresponds to the directory server. The example in FIG. 2 shows that the directory server's corresponding host name is “ldap.example.com.”

In order to answer question 250, the user enters a user identifier in box 255 that corresponds to the directory server. The example in FIG. 2 shows that the user entered “uid=wpsadmin,cn=users,dc=example,dc=com” as a user id. In order to answer question 260, the user enters a password in box 245 that corresponds to the user id that is entered in box 255. The example in FIG. 2 shows that the user entered “mypassword” to correspond to the user id that is entered in box 250.

As one skilled in the art can appreciate, the customized instruction generator may ask other computer system related questions, such as “Will you use a DB2, Oracle, or Cloudscape database?” and “Will you be installing the server in Windows, AIX or Solaris?”

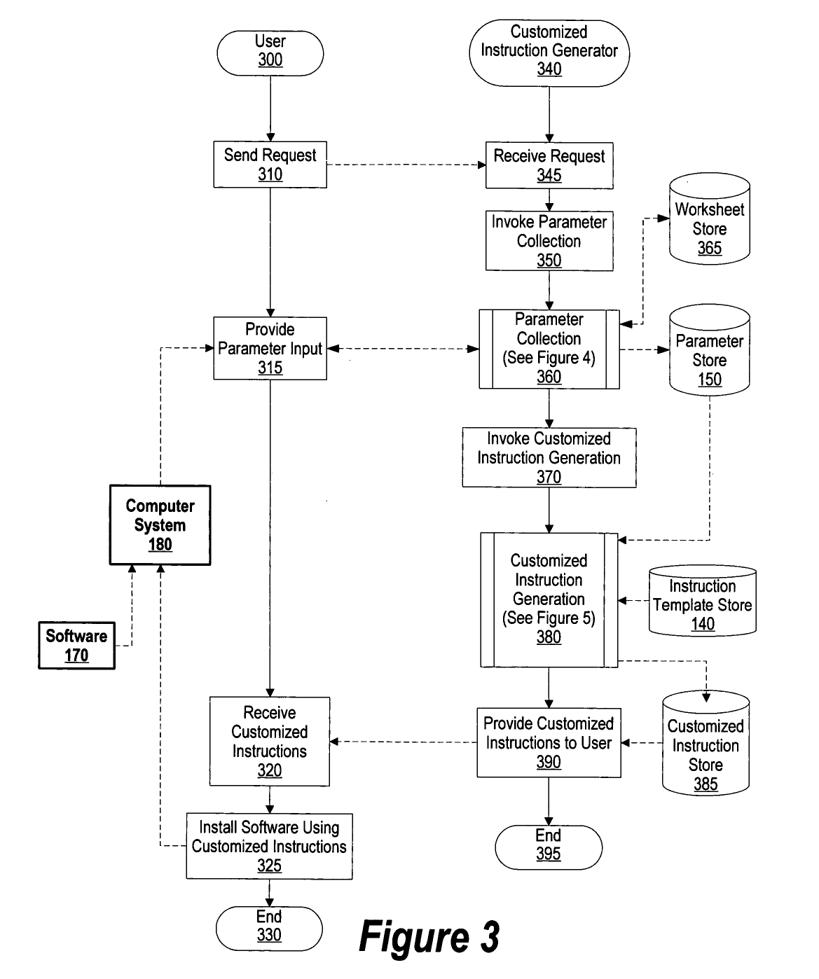

FIG. 3 is a high-level flowchart showing steps taken in a user providing system parameters and receiving customized instructions, which the user follows in order to load software on a computer system. User activity commences at 300, whereupon the user sends a request at step 310. For example, the user may request a client computer system to initiate the generation of customized instructions for a particular software installation process.

Customized instruction processing commences at 340, whereupon processing receives the user request at step 345. Processing invokes a system parameter collection process at step 350, whereby processing asks the user particular questions in order to receive system parameters that correspond to the user's computer system (pre-defined process block 360, see FIG. 4 and corresponding text for further details). During the collection process, processing retrieves questions from worksheet store 365 and provides them to the user. In turn, the user provides system parameters that correspond to computer system 180 (step 315). Processing stores the received system parameters in parameter store 150. Worksheet store 365 may be stored on a nonvolatile storage area, such as a computer hard drive. Computer system 180 and parameter store 150 are the same as that shown in FIG. 1.

After system parameters are collected, processing invokes customized instruction generation at step 370. Processing retrieves an instruction template from instruction template store 140, which includes parameter placeholders, such as “host name” and “user id.” Processing replaces the parameter placeholders with system parameters that are stored in parameter store 150, and generates customized instructions, which it stores in customized instruction store 385 (pre-defined process block 380, see FIG. 5 and corresponding text for further details). Customized instruction store 385 may be stored on a nonvolatile storage area, such as a computer hard drive. Instruction template store 140 is the same as that shown in FIG. 1. Once processing generates the customized instructions, processing provides the customized instructions to the user at step 390, and processing ends at 395.

The user receives the customized instructions at step 320, and installs software 170 in computer system 180 using the customized instructions (step 325). Software 170 is the same as that shown in FIG. 1. User activity ends at 330.

FIG. 4 is detail level flowchart showing steps taken in displaying questions and receiving system parameters that correspond to the questions. Parameter collection processing commences at 400, whereupon processing retrieves a first top-level question from worksheet store 365 at step 410. For example, a first top-level question may be “Do you want to use a directory server?”

Processing displays the top-level question to user 120 at step 420. User 120 is the same as that shown in FIG. 1. Processing receives an answer, or system parameter, corresponding to the top-level question at step 430. Using the example described above, processing may receive a “Yes” answer. Processing stores the received system parameter in parameter store 150 at step 440. Parameter store 150 is the same as that shown in FIG. 1.

A determination is made as to whether the user's answer to the top-level question requires corresponding dependent questions (decision 445). Using the example described above, if the user is not planning on using a directory server, then processing is not required to ask questions related to a directory server. If there are no dependent questions to receive answers, decision 445 branches to “No” branch 447 bypassing dependent question-answering steps.

On the other hand, if there are dependent questions to receive answers, decision 445 branches to “Yes” branch 449 whereupon processing displays dependent questions to user 120 at step 450. In turn, processing receives system parameters corresponding to the dependent questions (step 460), and stores the system parameters in parameter store 150 at step 470.

A determination is made as to whether there are more top-level questions to receive answers (decision 480). If there are more top-level questions, decision 480 branches to “Yes” branch 482 whereupon processing loops back to retrieve (step 490) and process the next top-level question. This looping continues until there are no more top-level questions to process, at which point decision 480 branches to “No” branch 488 whereupon processing returns at 495.

FIG. 5 is a flowchart showing steps taken in generating customized instructions using system parameters. Processing commences at 500, whereupon processing retrieves a first instruction section, such as a paragraph, from instruction template 140 (step 510). Instruction template 140 is the same as that shown in FIG. 1 and may be stored on a nonvolatile storage area, such as a computer hard drive.

A determination is made as to whether the retrieved instruction section includes one or more parameter placeholders (decision 520). For example, the instruction section may be generalized instructions that are not dependent upon a user's computer system configuration. As another example, the instruction section may have a parameter placeholder such as “Host Name” which corresponds to the host name of the user's computer system. If the retrieved instruction section is not customizable, decision 520 branches to “No” branch 522 whereupon processing stores the instruction section, as is, in customized instruction store 385 (step 530). Customized instruction store 385 is the same as that shown in FIG. 3.

On the other hand, if the retrieved instruction section includes one or more parameter placeholders, decision 520 branches to “Yes” branch 528 whereupon processing retrieves system parameters that correspond to the instruction section's parameter placeholders (step 540). For example, if the parameter placeholder is “Host Name”, the retrieved system parameter may be “ldap.example.com.” The system parameters were received from a user and stored in parameter store 150 (see FIG. 4 and corresponding text for further details regarding system parameter collection steps). Parameter store 150 is the same as that shown in FIG. 1 and may be stored on a nonvolatile storage area, such as a computer hard drive.

At step 550, processing replaces the parameter placeholders with the retrieved system parameters. Using the example described above, in places where “Host Name” is located, processing replaces “Host Name” with “ldap.example.com.”

Processing identifies subsections that correspond to the retrieved system parameters at step 560. For example, if a user plans to use a directory server, processing identifies software installation instructions that correspond to a directory server. At step 570, processing generates a customized instruction section based upon the placeholders and sub-sections, and stores the generated customized instruction section in customized instruction section 385 at step 570 (see FIG. 6 and corresponding text for further details regarding a customized instruction example).

A determination is made as to whether there are more instruction sections to process (decision 580). If there are more instruction sections to process, decision 580 branches to “Yes” branch 582 which loops back to retrieve (step 590) and process the next instruction section. This looping continues until there are no more instruction sections to process, at which point decision 580 branches to “No” branch 588 whereupon processing returns at 595.

FIG. 6 is an example of customized instructions that are generated using collected system parameters. Window 600 shows and example of customized software installation instructions that are generated based upon particular system parameters, such as those shown in FIG. 2. A user provides the system parameters to a customized instruction generator that, in turn, uses the system parameters and an instruction template to generate customized instructions (see FIGS. 1, 5, and corresponding text for further details regarding instruction generation). As one skilled in the art can appreciate, the instructions shown in window 600 may be printed for a user to view.

Window 600 includes line 610, which informs a user that the installation instructions that follow correspond to an LDAP server. For example, a user may have informed the customized instruction generator that the user is using an LDAP server as a directory server, such as the example shown in FIG. 2. Line 620 is a command line that includes specific system parameters to test a connection to an LDAP server. Box 625 includes text that is specific to a server of type “IDS”, or IBM Directory Server. Box 630 includes text specifically for a server whose host name is “ldap.example.com.” Boxes 635 and 640 include text that is specific to a user id “wpsadmin,cn=users,dc=example,dc=com” with a corresponding password “mypassword”, respectively.

Line 650 is a command line that includes specific system parameters to enable a portal server to use an LDAP server. Box 655 includes text specifically for a server of type “IDS”, or IBM Directory Server. Box 660 includes text specifically for a server whose host name is “ldap.example.com.” Boxes 665 and 670 include text that is specific to a user id “wpsadmin,cn=users,dc=example,dc=com” with a corresponding password “mypassword”, respectively.

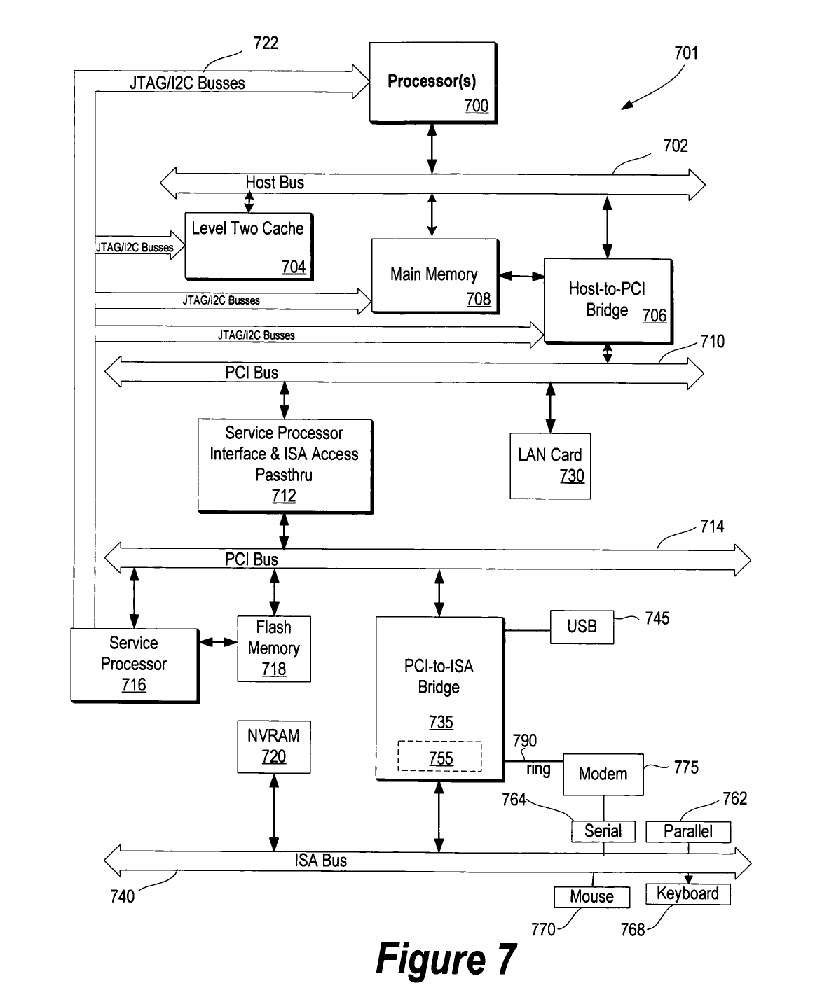

FIG. 7 illustrates information handling system 701 which is a simplified example of a computer system capable of performing the computing operations described herein. Computer system 701 includes processor 700 which is coupled to host bus 702. A level two (L2) cache memory 704 is also coupled to host bus 702. Host-to-PCI bridge 706 is coupled to main memory 708, includes cache memory and main memory control functions, and provides bus control to handle transfers among PCI bus 710, processor 700, L2 cache 704, main memory 708, and host bus 702. Main memory 708 is coupled to Host-to-PCI bridge 706 as well as host bus 702. Devices used solely by host processor(s) 700, such as LAN card 730, are coupled to PCI bus 710. Service Processor Interface and ISA Access Pass-through 712 provides an interface between PCI bus 710 and PCI bus 714. In this manner, PCI bus 714 is insulated from PCI bus 710. Devices, such as flash memory 718, are coupled to PCI bus 714. In one implementation, flash memory 718 includes BIOS code that incorporates the necessary processor executable code for a variety of low-level system functions and system boot functions.

PCI bus 714 provides an interface for a variety of devices that are shared by host processor(s) 700 and Service Processor 716 including, for example, flash memory 718. PCI-to-ISA bridge 735 provides bus control to handle transfers between PCI bus 714 and ISA bus 740, universal serial bus (USB) functionality 745, power management functionality 755, and can include other functional elements not shown, such as a real-time clock (RTC), DMA control, interrupt support, and system management bus support. Nonvolatile RAM 720 is attached to ISA Bus 740. Service Processor 716 includes JTAG and I2C busses 722 for communication with processor(s) 700 during initialization steps. JTAG/I2C busses 722 are also coupled to L2 cache 704, Host-to-PCI bridge 706, and main memory 708 providing a communications path between the processor, the Service Processor, the L2 cache, the Host-to-PCI bridge, and the main memory. Service Processor 716 also has access to system power resources for powering down information handling device 701.

Peripheral devices and input/output (I/O) devices can be attached to various interfaces (e.g., parallel interface 762, serial interface 764, keyboard interface 768, and mouse interface 770 coupled to ISA bus 740. Alternatively, many I/O devices can be accommodated by a super I/O controller (not shown) attached to ISA bus 740.

In order to attach computer system 701 to another computer system to copy files over a network, LAN card 730 is coupled to PCI bus 710. Similarly, to connect computer system 701 to an ISP to connect to the Internet using a telephone line connection, modem 775 is connected to serial port 764 and PCI-to-ISA Bridge 735.

While the computer system described in FIG. 7 is capable of executing the processes described herein, this computer system is simply one example of a computer system. Those skilled in the art will appreciate that many other computer system designs are capable of performing the processes described herein.

One of the preferred implementations of the invention is an application, namely, a set of instructions (program code) in a code module which may, for example, be resident in the random access memory of the computer. Until required by the computer, the set of instructions may be stored in another computer memory, for example, on a hard disk drive, or in removable storage such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

1. A method comprising:
retrieving an instruction template, wherein the instruction template includes one or more parameter placeholders;
identifying one or more system parameters that corresponds to one or more of the parameter placeholders; and
generating customized instructions using the instruction template, the generating including replacing one or more of the parameter placeholders with one or more of the identified system parameters.

2. The method of claim 1 wherein the customized instructions correspond to software code, the customized instructions including instructions to load the software code on a computer system.

3. The method of claim 1 further comprising:
displaying a top-level question to a user, the top level question corresponding to one of the system parameters; and
receiving one of the system parameters from the user in response to the displaying.

4. The method of claim 3 further comprising:
analyzing the received system parameter;
determining whether to display one or more dependent questions in response to the analyzing; and
displaying one or more of the dependent questions to the user based upon the determination.

5. The method of claim 1 wherein at least one of the system parameters is selected from the group consisting of a directory server, a host name, a user id, and a password.

6. The method of claim 1 wherein the instruction template is divided into a plurality of instruction sections, the method further comprising:
selecting a first instruction section from the plurality of instruction sections;
determining that one of the parameter placeholders included in the first instruction section corresponds to a second instruction section; and
including the second instruction section in the generated customized instructions.

7. The method as described in claim 1 wherein the instruction template is divided into a plurality of instruction sections, the method further comprising:
selecting a first instruction section;
determining that the first instruction section does not include one of the parameter placeholders; and
including the first instruction section in the customized instructions without changing the first instruction section.

8. An information handling system comprising:
one or more processors;
a memory accessible by the processors;
one or more nonvolatile storage devices accessible by the processors; and
a customized instruction generation tool for generating customized instructions, the customized instruction generation tool comprising software code effective to:
retrieve an instruction template from one of the nonvolatile storage devices, wherein the instruction template includes one or more parameter placeholders;
identify one or more system parameters that corresponds to one or more of the parameter placeholders; and
generate customized instructions using the instruction template, the generating including replacing one or more of the parameter placeholders with one or more of the identified system parameters.

9. The information handling system of claim 8 wherein the customized instructions correspond to software installation code, the customized instructions including instructions to load the software installation code on a computer system.

10. The information handling system of claim 8 wherein the software code is further effective to:
display a top-level question to a user on a display, the top level question corresponding to one of the system parameters; and
receive one of the system parameters from the user in response to the displaying.

11. The information handling system of claim 10 wherein the software code is further effective to:
analyze the received system parameter;
determine whether to display one or more dependent questions on a display in response to the analyzing; and
display one or more of the dependent questions on the display to the user based upon the determination.

12. The information handling system of claim 8 wherein at least one of the system parameters is selected from the group consisting of a directory server, a host name, a user id, and a password.

13. The information handling system of claim 8 wherein the instruction template is divided into a plurality of instruction sections, and wherein the software code is further effective to:
select a first instruction section from the plurality of instruction sections located in one of the nonvolatile storage devices;
determine that one of the parameter placeholders included in the first instruction section corresponds to a second instruction section that is located in one of the nonvolatile storage devices; and
include the second instruction section in the generated customized instructions.

14. The information handling system as described in claim 8 wherein the instruction template is divided into a plurality of instruction sections, wherein the software code is further effective to:
select a first instruction section located in one of the nonvolatile storage devices;
determine that the first instruction section does not include one of the parameter placeholders; and
include the first instruction section in the customized instructions without changing the first instruction section.

15. A program product comprising:
computer operable medium having computer program code, the computer program code being effective to:
retrieve an instruction template, wherein the instruction template includes one or more parameter placeholders;
identify one or more system parameters that corresponds to one or more of the parameter placeholders; and
generate customized instructions using the instruction template, the generating including replacing one or more of the parameter placeholders with one or more of the identified system parameters.

16. The program product of claim 15 wherein the customized instructions correspond to software code, the customized instructions including instructions to load the software code on a computer system.

17. The program product of claim 15 wherein the computer program code is further effective to:
display a top-level question to a user, the top level question corresponding to one of the system parameters; and
receive one of the system parameters from the user in response to the displaying.

18. The program product of claim 17 wherein the computer program code is further effective to:
analyze the received system parameter;
determine whether to display one or more dependent questions in response to the analyzing; and
display one or more of the dependent questions to the user based upon the determination.

19. The program product of claim 15 wherein at least one of the system parameters is selected from the group consisting of a directory server, a host name, a user id, and a password.

20. The program product of claim 15 wherein the instruction template is divided into a plurality of instruction sections, and wherein the computer program code is further effective to:
select a first instruction section from the plurality of instruction sections;
determine that one of the parameter placeholders included in the first instruction section corresponds to a second instruction section; and
include the second instruction section in the generated customized instructions.

21. The program product as described in claim 15 wherein the instruction template is divided into a plurality of instruction sections, wherein the computer program code is further effective to:
select a first instruction section;
determine that the first instruction section does not include one of the parameter placeholders; and
include the first instruction section in the customized instructions without changing the first instruction section.

22. A method comprising:
displaying a top-level question to a user, the top level question corresponding to one or more system parameters included in a plurality of system parameters;
receiving one of the system parameters from the user in response to the displaying;
retrieving an instruction template, wherein the instruction template includes one or more parameter placeholders;
selecting one or more of the system parameters that corresponds to one or more of the parameter placeholders; and
generating customized instructions corresponding to software code using the instruction template, the generating including replacing one or more of the parameter placeholders with one or more of the selected system parameters, the customized instructions including instructions to load the software code on a computer system.

23. A method comprising:
retrieving an instruction template, wherein the instruction template includes one or more parameter placeholders, and wherein the instruction template is divided into a plurality of instruction sections;
identifying one or more system parameters that corresponds to one or more of the parameter placeholders; and
generating customized instructions using the instruction template, the generating further comprising:
replacing one or more of the parameter placeholders with one or more of the identified system parameters;
selecting a first instruction section from the plurality of instruction sections;
determining that one of the parameter placeholders included in the first instruction section corresponds to a second instruction section; and
including the second instruction section in the generated customized instructions.

24. An information handling system comprising:
one or more processors;
a memory accessible by the processors;
one or more nonvolatile storage devices accessible by the processors; and
a customized instruction generation tool for generating customized instructions, the customized instruction generation tool comprising software code effective to:
retrieve an instruction template from one of the nonvolatile storage devices, wherein the instruction template includes one or more parameter placeholders, and wherein the instruction template is divided into a plurality of instruction sections;
identify one or more system parameters that corresponds to one or more of the parameter placeholders; and
generate customized instructions using the instruction template, wherein the software code is further effective to:
replace one or more of the parameter placeholders with one or more of the identified system parameters;
select a first instruction section located in one of the nonvolatile storage devices from the plurality of instruction sections;
determine that one of the parameter placeholders included in the first instruction section corresponds to a second instruction section located in one of the nonvolatile storage devices; and
include the second instruction section in the generated customized instructions.

25. A program product comprising:
computer operable medium having computer program code, the computer program code being effective to:
retrieve an instruction template, wherein the instruction template includes one or more parameter placeholders, and wherein the instruction template is divided into a plurality of instruction sections;
identify one or more system parameters that corresponds to one or more of the parameter placeholders; and
generate customized instructions using the instruction template, wherein the computer program code is further effective to:
replace one or more of the parameter placeholders with one or more of the identified system parameters;
select a first instruction section from the plurality of instruction sections;
determine that one of the parameter placeholders included in the first instruction section corresponds to a second instruction section; and
include the second instruction section in the generated customized instructions.
